(19) United States
(12) Patent Application Publication
(10) Pub. No.: US 2021/0060471 A1
(43) Pub. Date: Mar. 4, 2021

(54) AIR CLEANER

(71) Applicants: HONDA MOTOR CO., LTD., Tokyo (JP); TIGERS POLYMER CORPORATION, Osaka (JP)

(72) Inventors: Miyuki OZONO, Saitama (JP); Shunsuke WATANABE, Hyogo (JP); Hiroaki SUWA, Hyogo (JP); Shunsuke SAKATA, Hyogo (JP); Yoshikatsu KAKEDAI, Hyogo (JP)

(73) Assignees: HONDA MOTOR CO., LTD., Tokyo (JP); TIGERS POLYMER CORPORATION, Osaka (JP)

(21) Appl. No.: 16/991,243

(22) Filed: Aug. 12, 2020

(30) Foreign Application Priority Data
Aug. 30, 2019 (JP) 2019-157977

(51) Int. Cl. B01D 46/00; B01D 46/52; F02M 35/024

(52) U.S. Cl. CPC B01D 46/0043; B01D 2279/60; F02M 35/02441; B01D 46/521

(57) ABSTRACT

An air cleaner includes a case having an internal space, a filter element capable of partitioning the internal space into first and second spaces, an intake port that introduces an air into the first space therethrough, an exhaust port that discharges an air from the second space, and at least one baffle part projecting toward the filter element from an inner surface of the case. The baffle part diffuses the air introduced into the first space and introduces the air to the filter element. The baffle part includes a first baffle part extending along an extending surface of the filter element. The first baffle part is curved so as to be away from a hypothetical straight line connecting the intake port and the exhaust port as the first baffle part extends from the intake port toward the exhaust port as viewed in a direction perpendicular to the extending surface.

### CROSS REFERENCE TO RELATED APPLICATIONS

The present application claims priority under 35 U.S.C. § 119 to Japanese Patent Application No. 2019-157977 filed Aug. 30, 2019, the entire contents of which are hereby incorporated by reference.

### BACKGROUND

### Technical Field

This disclosure relates to an air cleaner for filtering and purifying air, or a structure thereof. In particular, this disclosure relates to an air cleaner for filtering and purifying the air to be fed to an internal combustion engine, or a structure thereof.

### Related Art

Air cleaners which filter out dust from the air to purify the air are widely used in various applications, for example, internal combustion engines for motor vehicles such as motor cars and motorcycles, air conditioners, fuel cells, and air cooling systems for cells and electronic circuits. The air cleaners are to collect fine particles with high efficiency according to each application and are also to have characteristics that withstand a long-term use with less clogging.

A known example of air cleaners for automotive internal combustion engines is an air cleaner having a filter material in the form of a flat plate (a flat element). For example, Japanese Patent Application Laid-Open Publication No. 2000-346687 (JP 2000-346687 A) discloses an air cleaner having a filter material by which air is filtered. The air cleaner described in JP 2000-346687 A includes a cleaner element, a cleaner case that accommodates the cleaner element, and a diffusion plate that divides an intake flow. The inside of the cleaner case is partitioned by the cleaner element into a dirty-side space upstream of air flow and a clean-side space downstream of air flow. The dirty-side space is provided with an intake pipe coupled thereto, and the clean-side space is provided with an outlet pipe coupled thereto. The diffusion plate is disposed in the dirty-side space to divide an intake flow introduced through the intake pipe and guide the divided air to the cleaner element. The air that passed through the cleaner element flows out of the outlet pipe.

### SUMMARY

However, the air cleaner described in JP 2000-346687 A has the diffusion plate extending in a direction intersecting with the direction (surface direction) in which the cleaner element extends. Thus, for example, when the distance between the cleaner element and an end of the diffusion plate extending toward the cleaner element is short, the air introduced through the intake pipe may be not guided homogeneously or uniformly to the cleaner element, resulting in inhomogeneous contamination of the cleaner element with dust or inhomogeneous dust distribution on the cleaner element.

The inventors made intensive studies to solve the above problem and finally found the following: a baffle part (or an air-guiding part) is provided in a specific configuration, such as a configuration curved in a direction away from a hypothetical straight line connecting an intake port and an exhaust port or a configuration radially extending from near the intake port, on a surface of a case facing an extending surface of a filter element, and such a baffle part enables an air flow from the intake port to be diffused in a first space homogeneously or uniformly in a direction of the filter element and filtered and then to be discharged from a second space. That is, an air cleaner according to one aspect of this disclosure includes a case having an internal space, a filter element capable of partitioning the internal space into a first space and a second space, an intake port that introduces an air into the first space therethrough, an exhaust port that discharges an air from the second space, and at least one baffle part that projects or protrudes toward the filter element from an inner surface of the case and diffuses the air introduced into the first space and introduces the air to the filter element. The baffle part includes a first baffle part extending along an extending surface of the filter element. The first baffle part is curved so as to be away from a hypothetical straight line connecting the intake port and the exhaust port as the first baffle part extends from the intake port toward the exhaust port as viewed in a direction perpendicular to the extending surface.

The at least one baffle part may pass through a center of the filter element as viewed in the direction perpendicular to the extending surface.

The first baffle part may have a plurality of baffle bodies projecting from the inner surface of the case. The baffle bodies may be arranged so that a distance between adjacent two baffle bodies is larger toward the exhaust port from the intake port as viewed in the direction perpendicular to the extending surface.

The first baffle part may have a plurality of baffle bodies projecting from the inner surface of the case. As viewed in the direction perpendicular to the extending surface, the baffle body farthest of the baffle bodies away from the straight line may have a curvature larger than the baffle body nearest the straight line does.

The first baffle part may have a plurality of baffle bodies projecting from the inner surface of the case. As viewed in the direction perpendicular to the extending surface, a baffle body farther of the baffle bodies away from the straight line may have a larger curvature.

The first baffle part may have a first end (hereinafter may be referred to as a proximal end) close to or near the intake port and a second end (hereinafter may be referred to as a distal end) opposite to the first end. The first baffle part may have a curvature increased monotonically toward the second end from the first end.

The baffle part may further include a second baffle part. The second baffle part may be disposed linearly in a direction intersecting with an opening surface of the intake port as viewed in the direction perpendicular to the extending surface of the filter element.

The straight line connecting the intake port and the exhaust port may be offset from a center of the filter element as viewed in the direction perpendicular to the extending surface.

### BRIEF DESCRIPTION OF DRAWINGS

FIG. 1 is an exploded perspective view showing an air cleaner according to a first embodiment of this disclosure.

FIG. 2 is a plan view showing an upstream case according to the first embodiment of this disclosure.

FIG. 3 is a cross-sectional view showing a baffle body and the upstream case shown in FIG. 2.

FIG. 4 is a view schematically illustrating an air flow in an air cleaner according to a reference example.

FIG. 5 is a view schematically illustrating an air flow in the air cleaner according to the first embodiment of this disclosure.

FIG. 6 is a view showing a first modification of a baffle body according to the first embodiment of this disclosure.

FIG. 7 is a view showing a second modification of the baffle body according to the first embodiment of this disclosure.

FIG. 8 is a plan view showing an upstream case according to a second embodiment of this disclosure.

### DESCRIPTION OF EMBODIMENTS

Hereinafter, an air cleaner according to embodiments of this disclosure will be described in detail with reference to the drawings. The air cleaner is used for, for example, a motor vehicle including a motor car and filters air to be supplied to an internal combustion engine of the motor vehicle. Hereinafter, the same reference numerals are used to refer to the same, similar or corresponding members or parts or components. As used herein, the term “substantially” refers to the complete or nearly complete extent or degree of an action, characteristic, property, state, structure, item, or result. As an arbitrary example, an object that is “substantially” enclosed would mean that the object is either completely enclosed or nearly completely enclosed. For example, the term “substantially parallel” means “parallel” or “substantially parallel”.

### First Embodiment

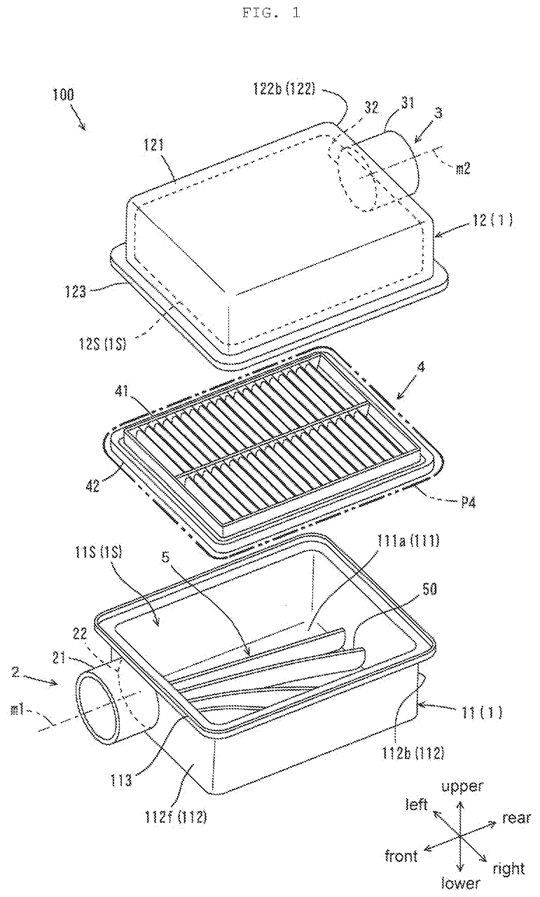

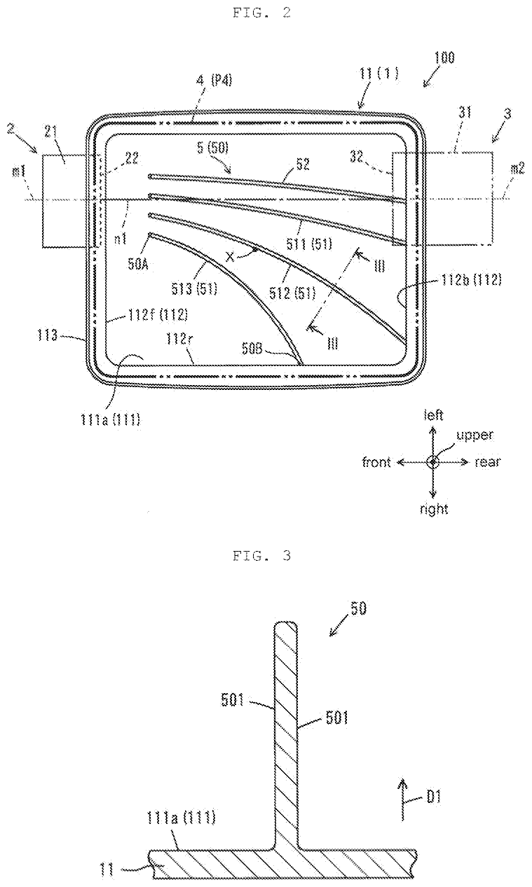

With reference to FIG. 1 to FIG. 3, an air cleaner 100 according to a first embodiment will be described. FIG. 1 is an exploded perspective view showing the air cleaner 100 according to the first embodiment. FIG. 2 is a plan view showing an upstream case 11 according to the first embodiment. In FIG. 2, a narrow long dashed double-short dashed line shows an exhaust pipe 31 and an exhaust port 32, and a wide long dashed double-short dashed line shows a filter element 4. FIG. 3 is a cross-sectional view showing a baffle body 50 and the upstream case 11 shown in FIG. 2. Specifically, FIG. 3 is a cross-sectional view taken along line III-III of FIG. 2. A direction of an arrow D1 in FIG. 3 indicates a projecting direction.

As shown in FIG. 1, the air cleaner 100 includes a case 1 having an internal space 1S, and a filter element 4 capable of partitioning the internal space 1S into an upstream first space 11S and a downstream second space 12S. The filter element 4 has an extending surface P4 (a main surface). The extending surface P4 includes a direction in which the filter element 4 extends.

The case 1 includes the upstream case 11 and a downstream case 12. The first space 11S is a space defined by the upstream case 11 and the filter element 4. The second space 12S is a space defined by the downstream case 12 and the filter element 4.

The air cleaner 100 further includes an intake part 2 that introduces air into the first space 11S, and an exhaust part 3 for discharging the air taken in the internal space 1S via the intake part 2 to the outside of the air cleaner 100. The air introduced into the first space 11S passes through the filter element 4 to be introduced into the second space 12S. The air to be introduced into the second space 12S is filtered by the filter element 4. That is, the filter element 4 removes dust from the air. The air introduced into the second space 12S is discharged outside the case 1 through the exhaust part 3. Thus, clean air is discharged outside the air cleaner 100.

Hereinafter, according to the configuration shown in FIG. 1, the side on which the upstream case 11 is located in the air cleaner 100 is referred to as a “lower side”, the side opposite to the “lower side” is described as an “upper side”, the side on which the intake part 2 is provided in the air cleaner 100 is referred to as a “front side”, the side opposite to the “front side” is described as a “rear side”, the left side viewed from the front side of the air cleaner 100 is described as a “left side”, and the side opposite to the “left side” is described as a “right side.” However, these definitions do not limit the orientation in use of the air cleaner 100. Hereinafter, the left-right direction may be referred to as the “width direction of the air cleaner 100”, and the upper-lower direction may be referred to as the “height direction of the air cleaner 100.”

The upstream case 11 and the downstream case 12 can each be produced by injection molding of a thermoplastic resin representatively. Examples of the thermoplastic resin may include a polyester resin, a polypropylene resin, and a polyamide resin. If necessary, at least one of the upstream case 11 and the downstream case 12 may be integrally formed or molded with a support stay (not shown).

The upstream case 11 is box-shaped being substantially rectangular in a plan view, having an opening toward the downstream case 12 (or upward). The upstream case 11 has a bottom wall 111 having a bottom surface (inner bottom surface) 111a and facing the downstream case 12, a first side wall 112 rising from a peripheral edge of the bottom wall 111, and a first flange 113 extending outward from an upper edge of the first side wall 112. The first side wall 112 has a front wall 112f provided with the intake part 2, and a first rear wall 112b facing the front wall 112f in the front-rear direction.

The intake part 2 has an intake pipe 21 projecting outward from the case 1, and an intake port 22 allowing the intake pipe 21 and the first space 11S to communicate with each other to introduce air into the first space 11S. In this embodiment, the intake pipe 21 extends in the horizontal direction or in substantially parallel with the bottom surface 111a. To the intake pipe 21, representatively, an upstream intake duct (not shown) or a silencer (not shown) is coupled.

As shown in FIG. 2, the intake port 22 is disposed at a position deviated to one side from the center of the front wall 112f. That is, the intake port 22 is offset from the center of the upstream case 11 in the width direction. Specifically, the intake pipe 21 (the central axis m1 of the intake pipe 21) and the intake port 22 are offset to the left from the center of the front wall 112f and are offset from the center X of the filter element 4. The center X of the filter element 4 may be referred to as the center X of the extending surface P4 of the filter element 4 provided in the internal space 1S. Hereinafter, the direction in which the intake port 22 is offset is referred to as a “first offset direction”. In this embodiment, the first offset direction is a direction from the right to the left.

As shown in FIG. 1, the downstream case 12 is box-shaped being substantially rectangular in a plan view, having an opening toward the upstream case 11 (or downward). The downstream case 12 has a top wall 121 having a top surface facing the upstream case 11, a second side wall 122 extending downward from a peripheral edge of the top wall 121 to surround the top wall 121, and a second flange 123 extending outward from a lower edge of the second side wall 122.

The second side wall 122 has a second rear wall 122b constituting a back surface of the downstream case 12. In an assembled state of the air cleaner 100, the second rear wall 122b and the first rear wall 112b are in the same plane. That is, a plane containing the second rear wall 122b and the first rear wall 112b faces the front wall 112f. And the second rear wall 122b faces the front wall 112f, being different in height position from the front wall 112f.

The exhaust part 3 has an exhaust pipe 31 projecting outward from the case 1, and an exhaust port 32 allowing the exhaust pipe 31 and the second space 12S to communicate with each other to discharge air from the second space 12S to the outside of the case 1. In this embodiment, the exhaust pipe 31 extends in the horizontal direction or in substantially parallel with the top surface of the top wall 121. To the exhaust pipe 31, representatively, a part such as a downstream duct (not shown) or a throttle body (not shown) is coupled. The upstream intake duct or the silencer is coupled to the intake pipe 21 and the downstream duct or the throttle body is coupled to the exhaust pipe 31, forming an air intake path to an internal combustion engine.

In this embodiment, the exhaust port 32 faces the intake port 22, being different in height position from the intake port 22 in an assembled state of the air cleaner 100. Specifically, as shown in FIG. 2, the exhaust port 32 is arranged substantially on a hypothetical straight line extending from the central axis m1 of the intake pipe 21 (intake port 22) in a plan view or as viewed from a direction perpendicular to the extending direction of the filter element 4. That is, a hypothetical straight line n1 connecting the intake port 22 (the central axis m1 of the intake pipe 21) and the exhaust port 32 (the central axis m2 of the exhaust pipe 31) is coaxial with the central axis m1 of the intake pipe 21. Thus, the straight line n1 is offset from the center X of the filter element 4. Hereinafter, the direction in which the straight line n1 is offset is referred to as a “second offset direction”. In this embodiment, the second offset direction is a direction from the right to the left and agrees with the first offset direction.

As shown in FIG. 1, the filter element 4 is a flat member being substantially rectangular in a plan view. The filter element 4 has outside dimensions in a plan view substantially the same as the outside dimensions of the upstream case 11 and those of the downstream case 12. The filter element 4 is supported between the upstream case 11 (the first flange 113) and the downstream case 12 (the second flange 123) so as to be substantially parallel with the bottom wall 111 (the bottom surface 11a) of the upstream case 11. That is, the filter element 4 (the extending surface P4) extends in a substantially parallel direction with respect to the central axis m1 of the intake pipe 21 (see FIG. 2) or a direction of an air flow drawn from the intake port 22. In this embodiment, the intake pipe 21 is configured to allow air to flow in a direction substantially parallel with the extending surface P4 of the filter element 4 at or near the intake port 22. The intake pipe 21, however, may or may not be configured to allow air to flow in a direction substantially parallel with the extending surface P4 of the filter element 4 at or near the intake port 22.

The filter element 4 has a filter material 41 and a seal member 42. The filter material 41 is a flat member being substantially rectangular in a plan view. The seal member 42 is disposed to surround the periphery of the filter material 41 in order to prevent leakage of air from a gap between the upstream case 11 and the downstream case 12. The filter element 4 may have a frame capable of supporting the filter material 41 by surrounding the filter material 41.

The filter material 41 representatively includes a pleated paper filter or a pleated nonwoven fabric. Alternatively, the filter material 41 may be an open-cell resin foam or sponge having a flat form. The filter material 41 may be a viscous filter material impregnated with oil or others, or may be a dry filter material having no impregnated oil or others.

As shown in FIG. 1 and FIG. 2, the air cleaner 100 further includes a baffle part 5 that diffuses the air flowing in the first space 11S to introduce the air flow to the filter element 4. The baffle part 5 includes a plurality of baffle bodies 50 disposed on the bottom surface 111a of the upstream case 11. The baffle bodies 50 are integrally formed or molded with the upstream case 11. For example, each one of the baffle bodies 50 is a plate member having a rib form or a fin form or a member having a bead form.

As shown in FIG. 1, the baffle body 50 projects from the bottom surface 111a (that is, the surface facing the filter element 4 in the case 1) toward the filter element 4 (the extending surface P4). Hereinafter, the direction in which the baffle body 50 projects may be referred to as a “projecting direction”. The projecting direction representatively corresponds to a direction removing a core for forming the baffle body 50 and the inner periphery of the case 1 in forming the upstream case 11 by injection molding.

The baffle body 50 extends along the extending surface P4. In this embodiment, the baffle body 50 continuously extends to the first side wall 112 along the extending surface P4.

As shown in FIG. 2, the baffle body 50 has a first end (proximal end or upstream end) 50A close to or near the intake port 22 and a second end (distal end or downstream end) 50B opposite to the first end 50A. The second end 50B is connected to the first side wall 112. The second end 50B of the baffle body 50, however, may or may not be connected to the first side wall 112. That is, there may be a distance between the baffle body 50 and the inner surface of the first side wall 112.

In this embodiment, the baffle bodies 50 are arranged in a configuration in which each first end 50A faces the intake port 22. The baffle bodies 50 are arranged at intervals with each other in the left-right direction.

The baffle bodies 50 are arranged to extend radially from near the intake port 22 as viewed in a direction perpendicular to the extending surface P4. Specifically, the baffle bodies 50 are arranged radially or in a radial pattern so that a distance between second ends 50B of adjacent two baffle bodies 50 is longer than a distance between first ends 50A thereof. That is, the baffle bodies 50 are arranged radially so that distances between adjacent two baffle bodies are increased from the intake port toward the exhaust port.

The baffle bodies 50 include three curved baffle bodies 51 and a linear baffle body 52. The three curved baffle bodies 51 include a first curved baffle body 511, a second curved baffle body 512, and a third curved baffle body 513. The curved baffle body 51 constitutes a first baffle part. The linear baffle body 52 constitutes a second baffle part.

Each one of the curved baffle bodies 51 is substantially arc-shaped in a plan view and is curved in a direction opposite to the second offset direction. The curved baffle body 51 is curved so as to be away from the straight line n1 connecting the intake port and the exhaust port as the baffle body extends from the intake port toward the exhaust port as viewed in the direction perpendicular to the extending surface P4. That is, as viewed in the direction perpendicular to the extending surface P4 of the filter element 4, the curved baffle body 51 is curved in a direction away from the straight line n1 in a direction from the first end 50A toward the second end 50B, i.e., is curved from the left to the right. In this embodiment, the first curved baffle body 511, the second curved baffle body 512, and the third curved baffle body 513 each have a constant curvature.

The baffle body 51 farthest away from the straight line n1 has a curvature larger than the baffle body 51 nearest the straight line n1 has. Specifically, the third curved baffle body 513 has a curvature larger than the first curved baffle body 511 has. The curved baffle bodies 51 are configured so that a baffle body farther of the baffle bodies away from the straight line n1 has a larger curvature. Specifically, the curvature of each baffle body 51 is set so that a baffle body farther away from the straight line n1 has a larger curvature gradually. In this embodiment, the ascending order in curvature is the first curved baffle body 511, the second curved baffle body 512, and the third curved baffle body 513, and the increasing rate in curvature is constant. That is, the curvature gradually increases in the ascending order of the first curved baffle body 511, the second curved baffle body 512, and the third curved baffle body 513.

The first curved baffle body 511 and the second curved baffle body 512 each extend from the position facing the intake port 22 to the first rear wall 112b of the upstream case 11. In this embodiment, the first curved baffle body 511 extends to a position corresponding to the exhaust port 32 in the first rear wall 112b of the upstream case 11. And the second curved baffle body 512 extends to or near the right corner of the first rear wall 112b of upstream case 11 in substantially parallel with a diagonal of the filter element 4. The third curved baffle body 513 extends from the position facing the intake port 22 to a right-side wall 112r of the upstream case 11. Specifically, the third curved baffle body 513 extends to or near the center of the right-side wall 112r of the upstream case 11.

The linear baffle body 52 is positioned downstream in the first offset direction among the baffle bodies 50. Specifically, the linear baffle body 52 is disposed on the left side of the first curved baffle body 511. The linear baffle body 52 extends substantially linearly in a direction intersecting with the opening surface of the intake port 22 as viewed in the direction perpendicular to the extending surface P4 of the filter element 4; where the opening surface of the intake port 22 extends in the left-right direction and the upper-lower direction. Specifically, the linear baffle body 52 is across the straight line n1 at a slight angle.

As shown in FIG. 3, the baffle body 50 is a solid member and projects from the bottom surface 111a (the bottom wall 111) toward the filter element 4. The baffle body 50 may have a height, or a length projecting from the bottom surface 111a, adjusted to allow an air from the intake port 22 to smoothly flow along the baffle body 50. In this embodiment, the height of the baffle body 50 and the distance between the baffle body 50 and the filter element 4 are constant along the longitudinal direction of the baffle body.

The baffle body 50 has a guide surface 501 as either side. The guide surface 501 is substantially parallel with the projecting direction D1. The air flowing from the intake port 22 into the upstream case 11 flows along the guide surface, being diffused over the space (the first space 11S) surrounded with the guide surface 501 of the baffle body 50, the bottom surface 11a, the first side wall 112 (see FIG. 1), and/or others.

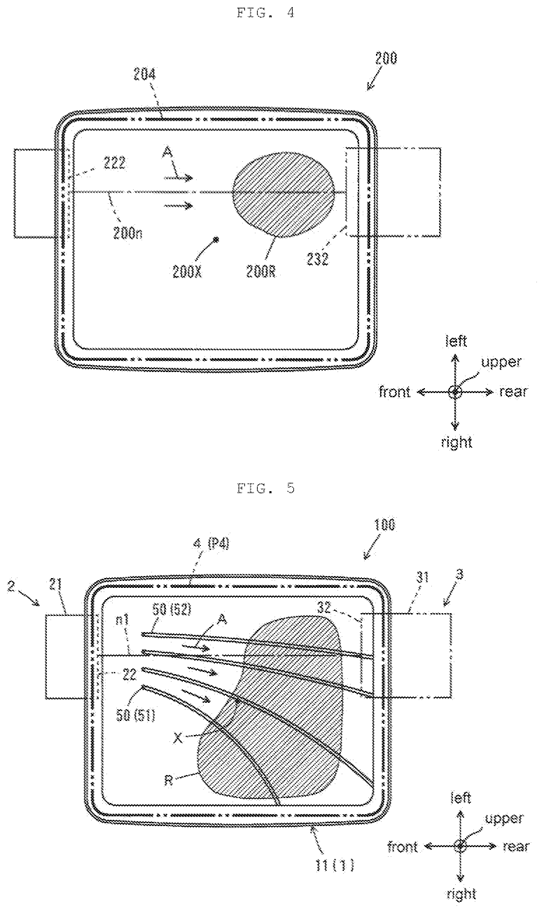

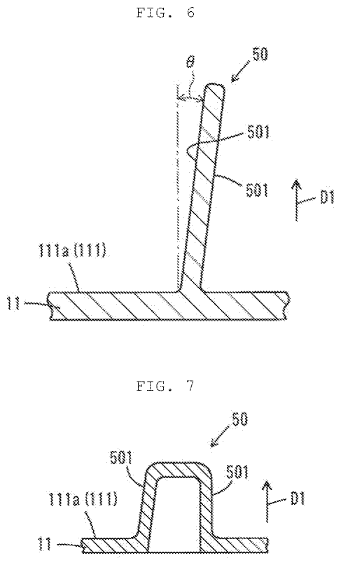

Hereinafter, with reference to FIG. 4 and FIG. 5, the functions and effects of the air cleaner 100 according to the first embodiment will be described.

FIG. 4 is a view schematically illustrating an air flow in an air cleaner 200 according to a reference example. FIG. 5 is a view schematically illustrating an air flow in the air cleaner 100 according to the first embodiment. The air cleaner 200 shown in FIG. 4 is different from the air cleaner 100 shown in FIG. 5 in the lack of the baffle body 50 on the upstream case 11.

As shown in FIG. 4, in the air cleaner 200 according to the reference example, a hypothetical straight line 200n connecting an intake port 222 and an exhaust port 232 is offset from a center 200X of a filter element 204. In the air cleaner 200 having such a configuration, an air flow from the intake port 222 tends to flow straightly along the straight line 200n and tends to be biased to one side (or a side in which the straight line 200n is offset) of the filter element 204 without diffusion. Thus, most of the air passes through a region of the filter element 204 overlapping or near the straight line 200n in a plan view. This leads to a tendency to collect dust contained in the air locally in a shaded region 200R in FIG. 4. The air cleaner 200 according to the reference example thus makes it difficult to uniformly use a filter material of the filter element 204 and difficult to allow dust to be homogeneously collected or distributed on the filter element 204.

In the air cleaner 200 according to the reference example, the straight line 200n connecting the intake port 222 and the exhaust port 232 is offset from the center 200X of the filter element 204, and thus most of the air tends to flow straightly toward the exhaust port 232. This phenomenon is also called short pass phenomenon of air flow. The short pass phenomenon causes the air flow to concentrate in a certain region of the filter element 204, and dust locally accumulates at the certain region of the filter element 204. This localized accumulation of dust may cause local deformation of the filter material 41 and/or dust leakage.

As shown in FIG. 5, the air cleaner 100 according to this embodiment is provided with the baffle body 50 that diffuses the air introduced from the intake port 22 into the first space 11S, and the filter element 4 is used uniformly. This allows the filter element 4 to collect dust in a homogeneous distribution of dust.

As described with reference to FIG. 2, the air cleaner 100 has the curved baffle body 51, having the first end 50A positioned near the intake port 22 and being curved in a direction in which the second end 50B is away from the central axis m1 of the intake pipe 21. Thus, the direction of the air flow introduced from the intake port 22 into the first space 11S is changed or diverged to a direction away from the straight line n1. This results in diffusion of the air to a region away from the straight line n1 in addition to a region overlapping or near the straight line n1 of the filter element 4 in a plan view, as shown in FIG. 5. This allows collection of dust in a shaded region R shown in FIG. 5. The filter element 4 in FIG. 5 thus can collect dust in a larger region compared with the filter element 204 shown in FIG. 4. This results in uniform use of the filter element 4 in FIG. 5 compared with the configuration shown in FIG. 4 and allows the filter element 4 to collect dust in a homogeneous distribution of dust.

Moreover, the diffusion of the air by the baffle part 5 prevents the air flow from concentrating in a certain region of the filter element 4. This reduces the occurrence of short pass phenomenon compared with the air cleaner 200 according to the reference example shown in FIG. 4 and prevents local deformation of the filter material 41 and/or dust leakage.

The first embodiment of this disclosure has been described above. According to the first embodiment, the air introduced into the first space 11S is diffused by the baffle bodies 50 and is introduced to the filter element 4. Thus, this prevents localized collection of dust in the filter element 4. That is, the filter element 4 is used uniformly, and this allows the filter element 4 to collect dust in a homogeneous distribution of dust.

Moreover, the air cleaner described in JP 2000-346687 A, in which the opening surface of the intake port is disposed in substantially parallel with the extending direction of the filter element, that is, in which the central axis of the intake port is substantially perpendicular to the extending direction of the filter element, may have a long total height (or a large length in the upper-lower direction). In contrast, according to this embodiment, the extending surface P4 of the filter element 4 intersects with the opening surface of the intake port 22. Such a configuration makes the total height of the air cleaner 100 small. This allows a space-saving design of the air cleaner 100 and a reduced installation space of the air cleaner 100. In some embodiments, the intake pipe 21 extends in substantially parallel with the extending surface P4 of the filter element or the bottom surface 11a of the case.

In this embodiment, the intake pipe 21 and the exhaust pipe 31 each project to the outside of the case 1 from a position offset with respect to the center in the width direction (or the left-right direction) of the case 1. This improves a flexibility of layout design compatible to an installation space of the air cleaner 100.

In this embodiment, the air is diffused and is guided or introduced to the filter element 4, even in a case where the straight line n1 connecting the intake port 22 and the exhaust port 32 is offset from the center of the width direction (or the left-right direction) of the case 1. This allows the filter element 4 to collect dust in a homogeneous distribution of dust.

In this embodiment, at least one of the curved baffle bodies 51 is curved to pass through the substantial center X of the filter element 4 in a plan view. Such a baffle body 50 facilitates smooth flow of the air to the substantial center X of the filter element 4 and reduces or prevents stagnation of the air in the first space 11S. Thus, in the first space 11S, the air flow is smooth and is efficiently diffused, and this allows the filter element 4 to collect dust in a more homogeneous distribution of dust.

In this embodiment, the curved baffle bodies 51 are arranged radially so that distances between adjacent two baffle bodies are increased in a direction from the intake port 22 toward the exhaust port 32. Such a configuration enables efficient diffusion of the air in the first space 11S.

In this embodiment, the curved baffle bodies 51 are configured so that the baffle body 51 farthest away from the straight line n1 (or the rightmost baffle body 51) has a curvature (or curve) larger than the baffle body 51 nearest the straight line n1 has. Such a configuration enables efficient diffusion of the air.

In this embodiment, the curved baffle bodies 51 are configured so that a baffle body 51 farther away from the straight line n1 has a larger curvature (or curve). Such a configuration enables efficient diffusion of the air.

In this embodiment, the linear baffle body 52 is inclined to a direction opposite to the second offset direction as the linear baffle body 52 extends away from the intake port 22 in a plan view. Such a configuration reduces or prevents the air flow from going straight and allows uniform use of the filter element 4.

In this embodiment, the guide surface 501 is disposed in substantially parallel with the projecting direction D1 (see FIG. 3). Such a configuration enables the air cleaner 100 to have a large gutter-shaped space (between adjacent baffle bodies 50) where the air flows. This results in the air flowing smoothly along the guide surface 501 of the baffle body 50. This enables efficient diffusion of the air.

As described with reference to FIG. 4, the short pass phenomenon occurs in the air cleaner 200 according to the reference example and may cause local deformation of the filter material. Alternatively, this may cause dust leakage. In contrast, according to this embodiment, the air flowing from the intake port 22 into first space 11S is diffused. Thus, the filter material 41 is prevented from local deformation due to short pass phenomenon of the air flow, even in a case where the straight line n1 connecting the intake port 22 and the exhaust port 32 is offset from the center of the width direction (or the left-right direction) of the case 1. Moreover, dust leakage due to the short pass phenomenon of the air flow is also prevented.

In this embodiment, each one of the curved baffle bodies 51 has a constant curvature. Each one of the curved baffle bodies 51 may have a curvature gradually increased at greater distances from the straight line n1. For example, each one of the curved baffle bodies 51 has a curvature increased monotonically toward the second end 50B from the first end 50A. Near the intake port 22 (or near the first end 50A), the air introduced into the first space 11S may be diffused insufficiently. In a case where each one of the curved baffle bodies 51 has a curvature gradually increased at greater distances from the straight line n1, the direction of the air flow is gradually changed. This results in sufficient diffusion of the air. Moreover, in a case where each one of the curved baffle bodies 51 has a curvature gradually increased at greater distances from the straight line n1, such curved baffle bodies facilitate smooth flow of the air along each curved baffle body 51. This results in more efficient diffusion of the air.

Each one of the curved baffle bodies 51 may have a sign inversion in the curvature or may be curved only in one direction without a sign inversion in the curvature, that is, may have a curvature with no inflection point. Alternatively, at least one of the curved baffle bodies 51 may have a linear portion. Such a configuration facilitates smooth flow of the air along each curved baffle body 51. This results in more efficient diffusion of the air.

In this embodiment, the linear baffle body 52 is inclined so as to intersect with the straight line n1 at or near the exhaust port. The linear baffle body 52 may be disposed linearly in substantially parallel with the left-hand or right-hand first side wall 112 of the upstream case 11. Such a configuration also results in more efficient diffusion of the air.

In this embodiment, the linear baffle body 52 is across the straight line n1. The linear baffle body 52 may or may not be across the straight line n1.

In this embodiment, the upstream case 11 and the downstream case 12 each are substantially rectangular in a plan view. Each of the upstream case 11 and the downstream case 12 may have any form that enables the air introduced from the intake pipe 21 to be filtered by the filter element 4 and then discharged from the exhaust pipe 31. For example, the forms of the upstream case 11 and the downstream case 12 may be substantially circular, substantially polygonal, or substantially elliptical in a plan view. In such a case, the form of the filter element 4 may be changed corresponding to the forms of the upstream case 11 and the downstream case 12.

In this embodiment, the second curved baffle body 512 passes through the substantial center X of the filter element 4 as viewed in the direction perpendicular to the extending surface P4. The second curved baffle body 512 does not necessarily need to pass through the substantial center X of the filter element 4. Any one of the baffle bodies 50 may pass through the substantial center X of the filter element 4.

In this embodiment, the second end 50B of the first curved baffle body 511 is positioned at or near the exhaust port 32 as viewed in the direction perpendicular to the extending surface P4. The second end 50B of any baffle body 50 is positioned at or near the exhaust port 32. The baffle body 50 of which the second end 50B is positioned at or near the exhaust port 32 is not limited to the first curved baffle body 511.

In this embodiment, an example having three curved baffle bodies 51 is shown. The number of curved baffle bodies 51 is at least one and may be one, two, or four or more. For example, the number of curved baffle bodies 51 may be two to five or three to four. In a case where the number of curved baffle bodies 51 is one, the curved baffle body 51 may be across the straight line n1. Moreover, the linear baffle body 52 is not necessarily needed. Alternatively, the number of linear baffle bodies 52 is not limited to one and may be two or more. The number of curved baffle bodies 51 and that of linear baffle bodies 52 may be changed, for example, according to at least one selected from the group consisting of the size of the air cleaner 100, the position of the intake port 22, and the position of the exhaust port 32.

In this embodiment, the baffle body 50 has a constant height. The baffle body 50 may or may not have a constant height. For example, the baffle body 50 may have a larger height at greater distances from the intake port 22. The baffle body 50 may have a regular or irregular height so as to be in a regular or irregular wave form in a side view.

In this embodiment, the first ends 50A of the baffle bodies 50 are positioned at substantially regular intervals in the width direction. The first ends 50A of the baffle bodies 50 may or may not be positioned at substantially regular intervals. For example, the baffle bodies 50 may be arranged so that the interval between adjacent two baffle bodies is larger at greater distances from the straight line n1.

In this embodiment, described is a configuration in which the guide surface 501 is substantially parallel with the projecting direction D1. As shown in FIG. 6, the guide surface 501 may be inclined with respect to the projecting direction D1 in a range that does not prevent the diffusion of the air. FIG. 6 is a view showing a first modification of the baffle body 50 according to the first embodiment. For example, an angle of inclination θ of the guide surface 501 with respect to the projecting direction D1 may be 20° or less (1° to 20°), particularly 10° or less.

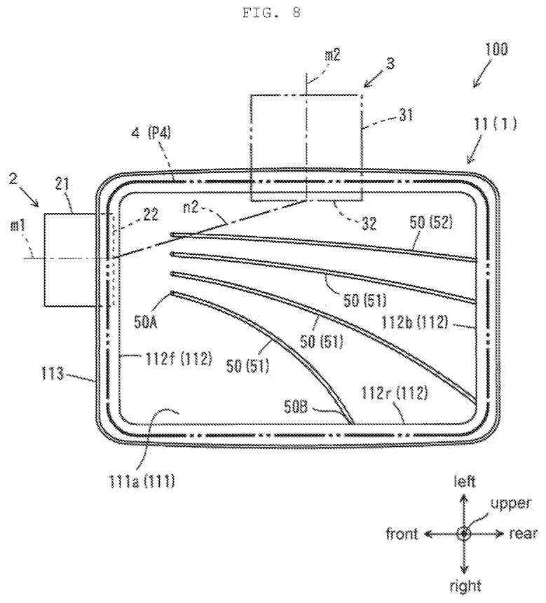

In this embodiment, the baffle body 50 is a solid member. The baffle body 50 is not limited to a solid member and may have any configuration that can diffuse an air flow (or air). FIG. 7 is a view showing a second modification of the baffle body 50 according to the first embodiment. As shown in FIG. 7, the baffle body 50 may be in a hollow bead form. Specifically, the baffle body 50 may have a hollow form projecting toward the side in which the upstream case 11 is opened (or upward). The baffle body 50 may have a solid portion and a hollow portion. In such a case, for example, the baffle body 50 may be in a solid rib form on the first end 50A and in a hollow bead form on the second end 50B. Alternatively, the baffle body 50 may be in a hollow form on the first end 50A and in a solid form on the second end 50B.

In this embodiment, the baffle body 50 (the curved baffle body 51 and the linear baffle body 52) is disposed continuously to the first side wall 112 along the extending surface P4. It is not necessary that the baffle part 5 continuously extend. The baffle part 5 may be formed discontinuously along the extending surface P4. In such a configuration, the baffle body 50 has a plurality of baffle pieces disposed regularly or irregularly along the extending surface P4. The baffle pieces may be uniform or non-uniform in size. Moreover, the interval between adjacent baffle pieces may or may not be constant.

In this embodiment, the straight line n1 connecting the intake port 22 and the exhaust port 32 is offset from the center X of the filter element 4. The straight line n1 may pass through the center X of the filter element 4. In such a case, the curved baffle body 51 may be disposed line-symmetrically with respect to the straight line n1.

In this embodiment, described is a configuration in which the exhaust port 32 is disposed at the second rear wall 122b, and the second rear wall 122b is parallel with the front wall 112f provided with the intake port 22. The wall at which the exhaust port 32 is disposed is not limited to the second rear wall 122b. For example, the exhaust port 32 may be disposed at a wall having a surface intersecting with the front wall 112f, for example, a right-side wall or a left-side wall.

### Second Embodiment

With reference to FIG. 8, an air cleaner 100 according to a second embodiment will be described. The second embodiment is different from the first embodiment in the position of the exhaust port 32. Hereinafter, the differences from the first embodiment will be described, and repeated description of the first embodiment will be omitted.

FIG. 8 is a plan view showing an upstream case 11 according to the second embodiment. In FIG. 8, a narrow long dashed double-short dashed line shows an exhaust pipe 31 and an exhaust port 32, and a wide long dashed double-short dashed line shows a filter element 4.

As shown in FIG. 8, the exhaust port 32 is disposed at a position different from a position facing the intake port 22 in the front-rear direction in a plan view. That is, the exhaust port 32 is not disposed substantially on a hypothetical straight line extending from the central axis m1 of the intake pipe 21 but is disposed at a position deviating from the hypothetical straight line extending from the central axis m1. Specifically, the exhaust port 32 is disposed at a left-hand second side wall 122 of the downstream case 12. Thus, a hypothetical straight line n2 connecting the intake port 22 and the exhaust port 32 is not coaxial with the central axis m1 of the intake pipe 21 and intersects with the central axis m1. Moreover, in this embodiment, the central axis m1 of the intake pipe 21 is perpendicular to the central axis m2 of the exhaust pipe 31. In this embodiment, the first offset direction intersects with the second offset direction.

The exhaust pipe 31 projects from the exhaust port 32 to the left. The exhaust pipe 31 extends in substantially parallel with the extending surface P4 or in the substantially horizontal direction. The central axis m2 of the exhaust pipe 31 is substantially parallel with the extending surface P4. As with the first embodiment, the intake pipe 21 extends in substantially parallel with the extending surface P4 or in the substantially horizontal direction. The central axis m1 of the intake pipe 21 is substantially parallel with the extending surface P4.

The second embodiment has been described above. According to the second embodiment, the air introduced into the first space 11S from the intake port 22 is diffused by the baffle bodies 50 and introduced to the filter element 4. Thus, this prevents localized collection of dust in the filter element 4. That is, the filter element 4 is used uniformly. This allows the filter element 4 to collect dust in a homogeneous distribution of dust.

The central axis m1 of the intake pipe 21 and the central axis m2 of the exhaust pipe 31 each extend in substantially parallel with the extending surface P4. The central axis m1 of the intake pipe 21 and/or the central axis m2 of the exhaust pipe 31 may be inclined upward or downward with respect to the extending surface P4. Moreover, the central axis m1 and/or the central axis m2 may be inclined with respect to the first side wall 112 and/or the second side wall 122 of the case 1 in the width direction.

Exemplary embodiments of this disclosure have been described above. However, this disclosure is not limited to the above-described embodiments, and can be implemented in various embodiments without departing from the scope thereof. The forms, shapes, and others shown in the above-described embodiments are only exemplary and not restrictive, and various modifications can be made without substantially departing from the effects of this disclosure.

For example, in the above embodiments of this disclosure, a configuration in which the air cleaner 100 includes two cases 1 independently formed (the upstream case 11 and the downstream case 12) and the filter element 4 supported between the two cases 1 is described as an example. The air cleaner 100 is not limited to this configuration and may have any configuration in which the filter element 4 can partition the internal space 1S into the first space 11S and the second space 12S. For example, the air cleaner 100 may include the filter element 4 put into a slit that is provided in a single or integrated case 1 and that extends in a width direction of the case 1.

In the above embodiments of this disclosure, a configuration in which the baffle body 50 is integrally formed or molded with the upstream case 11 is described. The baffle body 50 may be provided separately from the upstream case 11. Specifically, the baffle body 50 may be produced separately from the upstream case 11 and attached to the upstream case 11. The baffle body 50 may be attached by, for example, welding or bonding such as vibration welding.

The air cleaner 100 may include other members such as a resonance silencer (a resonator or a side branch). The resonance silencer may be provided integrally with the air cleaner. Alternatively, the inside of the upstream case 11 or the downstream case 12 may be partitioned so that part of the inside can serve as the resonance silencer. In this case, the baffle body 50 according to the above embodiments of this disclosure may serve as part of a partition.

The air cleaner 100 according to this disclosure is applied to an internal combustion engine for motor cars. The air cleaner 100 is also successfully applied to not only the internal combustion engine for motor cars but also various applications, for example, internal combustion engines for motorcycles, housing equipment, power generation equipment, and various industrial equipment.

According to this disclosure, the air diffused by the baffle part is uniformly introduced to the filter element and is filtered through the filter element. This allows the filter element to collect dust in a homogeneous distribution of dust.

The air cleaner according to this disclosure is applicable to internal combustion engines for motor vehicles such as motor cars and motorcycles, air conditioners, fuel cells, and air cooling systems for cells and electronic circuits.

This disclosure provides illustrative, non-limiting aspects as follows.

In a first aspect, there is provided an air cleaner including a case having an internal space, a filter element capable of partitioning the internal space into a first space and a second space, an intake port that introduces an air into the first space therethrough, an exhaust port that discharges an air from the second space, and at least one baffle part that projects toward the filter element from an inner surface of the case and diffuses the air introduced into the first space and introduces the air to the filter element. The baffle part includes a first baffle part extending along an extending surface of the filter element, and the first baffle part is curved so as to be away from a hypothetical straight line connecting the intake port and the exhaust port as the first baffle part extends from the intake port toward the exhaust port as viewed in a direction perpendicular to the extending surface.

In a second aspect, there is provided the air cleaner according to the first aspect, wherein the at least one baffle part passes through a center of the filter element as viewed in the direction perpendicular to the extending surface.

In a third aspect, there is provided the air cleaner according to the first or the second aspect, wherein the first baffle part has a plurality of baffle bodies projecting from the inner surface of the case, and the baffle bodies are arranged so that a distance between adjacent two baffle bodies is larger toward the exhaust port from the intake port as viewed in the direction perpendicular to the extending surface.

In a fourth aspect, there is provided the air cleaner according to any one of the first to the third aspects, wherein the first baffle part has a plurality of baffle bodies projecting from the inner surface of the case, and as viewed in the direction perpendicular to the extending surface, a baffle body farthest of the baffle bodies away from the straight line has a curvature larger than a baffle body nearest the straight line does.

In a fifth aspect, there is provided the air cleaner according to any one of the first to the fourth aspects, wherein the first baffle part has a plurality of baffle bodies projecting from the inner surface of the case, and as viewed in the direction perpendicular to the extending surface, a baffle body farther of the baffle bodies away from the straight line has a larger curvature.

In a sixth aspect, there is provided the air cleaner according to any one of the first to the fifth aspects, wherein the first baffle part has a first end close to the intake part and a second end opposite to the first end, and the first baffle part has a curvature increased monotonically toward the second end from the first end.

In a seventh aspect, there is provided the air cleaner according to any one of the first to the sixth aspects, wherein the baffle part further includes a second baffle part, and the second baffle part is disposed linearly in a direction intersecting with an opening surface of the intake port as viewed in the direction perpendicular to the extending surface.

In an eighth aspect, there is provided the air cleaner according to any one of the first to the seventh aspects, wherein the straight line connecting the intake port and the exhaust port is offset from a center of the filter element as viewed in the direction perpendicular to the extending surface.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An air cleaner comprising:
a case having an internal space,
a filter element capable of partitioning the internal space into a first space and a second space,
an intake port being configured to introduce an air into the first space therethrough,
an exhaust port being configured to discharge an air from the second space, and
at least one baffle part projecting toward the filter element from an inner surface of the case, the baffle part being configured to diffuse the air introduced into the first space and introduce the air to the filter element,
the baffle part comprising a first baffle part extending along an extending surface of the filter element, and the first baffle part being curved so as to be away from a hypothetical straight line connecting the intake port and the exhaust port as the first baffle part extends from the intake port toward the exhaust port as viewed in a direction perpendicular to the extending surface.

2. The air cleaner according to claim 1, wherein the at least one baffle part passes through a center of the filter element as viewed in the direction perpendicular to the extending surface.

3. The air cleaner according to claim 1, wherein
the first baffle part has a plurality of baffle bodies projecting from the inner surface of the case, and
the baffle bodies are arranged so that a distance between adjacent two baffle bodies is larger toward the exhaust port from the intake port as viewed in the direction perpendicular to the extending surface.

4. The air cleaner according to claim 1, wherein
the first baffle part has a plurality of baffle bodies projecting from the inner surface of the case, and
as viewed in the direction perpendicular to the extending surface, a baffle body farthest of the baffle bodies away from the straight line has a curvature larger than a baffle body nearest the straight line does.

5. The air cleaner according to claim 1, wherein the first baffle part has a plurality of baffle bodies projecting from the inner surface of the case, and
as viewed in the direction perpendicular to the extending surface, a baffle body farther of the baffle bodies away from the straight line has a larger curvature.

6. The air cleaner according to claim 1, wherein the first baffle part has a first end close to the intake part and a second end opposite to the first end, and
the first baffle part has a curvature increased monotonically toward the second end from the first end.

7. The air cleaner according to claim 1, wherein the baffle part further comprises a second baffle part, and the second baffle part is disposed linearly in a direction intersecting with an opening surface of the intake port as viewed in the direction perpendicular to the extending surface.

8. The air cleaner according to claim 1, wherein the straight line connecting the intake port and the exhaust port is offset from a center of the filter element as viewed in the direction perpendicular to the extending surface.
